(19) United States
(12) Patent Application Publication
(10) Pub. No.: US 2023/0213226 A1
(43) Pub. Date: Jul. 6, 2023

(54) SELF-CLEANING ADAPTER FOR ELECTRONIC AIR CLEANER

(71) Applicant: Carrier Corporation, Palm Beach Gardens, FL (US)

(72) Inventors: Michael J. Birnkrant, Manlius, NY (US); Peter Johannes McKinney, Boulder, CO (US); Shuguang Zhang, Shanghai (CN)

(21) Appl. No.: 18/088,141

(22) Filed: Dec. 23, 2022

Related U.S. Application Data
(60) Provisional application No. 63/296,348, filed on Jan. 4, 2022.

(51) Int. Cl. F24F 8/90; F24F 8/192

(52) U.S. Cl. CPC F24F 8/90; F24F 8/192

(57) ABSTRACT

A self-cleaning assembly for cleaning at least one electrode of an electronic air cleaner includes a mounting bracket removably connectable to the electronic air cleaner and a connecting member having at least one arm. The connecting member is rotatable about an axis. At least one cleaning body is arranged at a portion of the at least one arm.

### CROSS-REFERENCE TO RELATED APPLICATIONS

This application claims the benefit of U.S. Provisional Application No. 63/296,348 filed Jan. 4, 2022, the disclosure of which is incorporated herein by reference in its entirety.

### BACKGROUND

Embodiments of the present disclosure relate to the art of air treatment, and more particularly, a cleaning mechanism for cleaning an electronic ionization device.

Air and other fluids are commonly cleaned or purified in a variety of applications. For example, in air conditioning systems, the air to be delivered to an area being conditioned is not only conditioned, but is also filtered or otherwise treated prior to delivery. One device commonly used to perform such treatment is an electronic air cleaner. However, the performance of an electronic air cleaner will degrade over time as compounds and particulates in the air being treated adhere to the surface of the electrode(s).

### BRIEF DESCRIPTION

A self-cleaning assembly for cleaning at least one electrode of an electronic air cleaner includes a mounting bracket removably connectable to the electronic air cleaner and a connecting member having at least one arm. The connecting member is rotatable about an axis. At least one cleaning body is arranged at a portion of the at least one arm.

In addition to one or more of the features described herein, or as an alternative, in further embodiments the at least one arm further comprises a plurality of arms and the at least one cleaning body includes a plurality of cleaning bodies, each of the plurality of cleaning bodies being arranged at a portion of one of the plurality of arms.

In addition to one or more of the features described herein, or as an alternative, in further embodiments the plurality of arms includes a first arm and a second arm and a length of the first arm is equal to a length of the second arm.

In addition to one or more of the features described herein, or as an alternative, in further embodiments the plurality of arms includes a first arm and a second arm and a length of the first arm is different from a length of the second arm.

In addition to one or more of the features described herein, or as an alternative, in further embodiments the at least one cleaning body is located near an end of the at least one arm.

In addition to one or more of the features described herein, or as an alternative, in further embodiments the at least one cleaning body is located near a central portion of the at least one arm.

In addition to one or more of the features described herein, or as an alternative, in further embodiments the mounting bracket further comprises a plurality of pieces, the plurality of pieces being removably connected to one another.

In addition to one or more of the features described herein, or as an alternative, in further embodiments comprising a support shaft operably coupled to the connecting member and a motor operably coupled to the support shaft. A hollow interior is formed between the plurality of pieces and the motor is mounted within the hollow interior.

In addition to one or more of the features described herein, or as an alternative, in further embodiments comprising a support shaft operably coupled to the connecting member and a motor operably coupled to the support shaft. The support shaft extends through the mounting bracket.

According to an embodiment, an electronic air cleaner includes a brush array and an ionizing system including a brush assembly having at least one electrode. The at least one electrode is mounted to the brush array. A self-cleaning assembly is removably coupled to the brush array. The self-cleaning assembly includes at least one movable cleaning body operable to contact the at least one electrode.

In addition to one or more of the features described herein, or as an alternative, in further embodiments the at least one electrode further comprises a plurality of electrodes and the at least one movable cleaning body is operable to contact the plurality of electrodes.

In addition to one or more of the features described herein, or as an alternative, in further embodiments the brush array includes a body and the self-cleaning assembly further comprises a mounting bracket, the mounting bracket being removably connected to the body.

In addition to one or more of the features described herein, or as an alternative, in further embodiments the body further comprises a first arm and a second arm separated by a clearance, the mounting bracket being coupled to both the first arm and the second arm.

In addition to one or more of the features described herein, or as an alternative, in further embodiments at least a portion of the self-cleaning assembly is arranged within the clearance.

In addition to one or more of the features described herein, or as an alternative, in further embodiments the mounting bracket further comprises a plurality of pieces, the plurality of pieces being removably connected to one another.

In addition to one or more of the features described herein, or as an alternative, in further embodiments the self-cleaning assembly further comprises a motor, a support shaft operably coupled to the motor and rotatable about an axis, and at least one connecting member rotatably coupled to the support shaft. The at least one movable cleaning body is mounted to the at least one connecting member.

In addition to one or more of the features described herein, or as an alternative, in further embodiments the mounting bracket has a hollow interior and the motor is mounted within the hollow interior.

In addition to one or more of the features described herein, or as an alternative, in further embodiments the support shaft extends through the mounting bracket.

In addition to one or more of the features described herein, or as an alternative, in further embodiments the at least one electrode further comprises a plurality of electrodes and the support shaft is arranged centrally relative to the plurality of electrodes.

In addition to one or more of the features described herein, or as an alternative, in further embodiments the at least one connecting member includes a plurality of connecting members.

### BRIEF DESCRIPTION OF THE DRAWINGS

The following descriptions should not be considered limiting in any way. With reference to the accompanying drawings, like elements are numbered alike:

FIG. 1 is a perspective view of an exemplary electronic air cleaner having a plurality of self-cleaning adapters mounted thereto according to an embodiment;

FIG. 2 is a schematic diagram of an exemplary ionizing system of an electronic air cleaner according to an embodiment; and

FIG. 3 is a schematic diagram of an exemplary portion of a self-cleaning assembly according to an embodiment.

### DETAILED DESCRIPTION

A detailed description of one or more embodiments of the disclosed apparatus and method are presented herein by way of exemplification and not limitation with reference to the Figures.

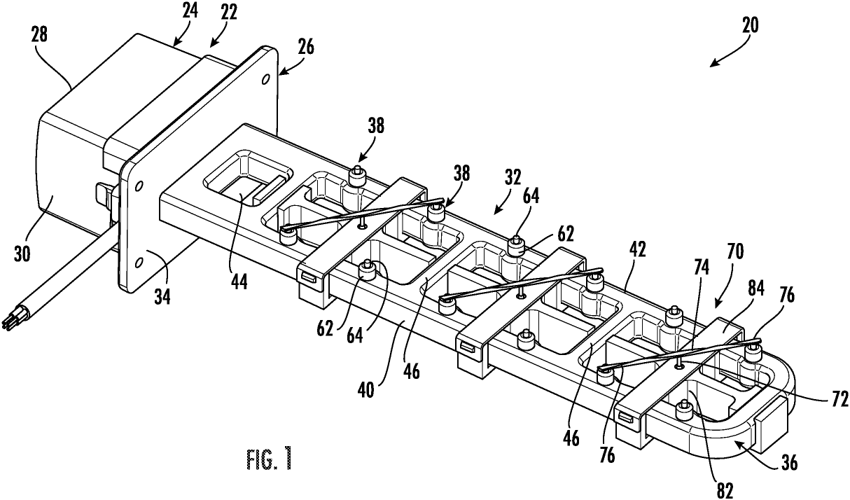

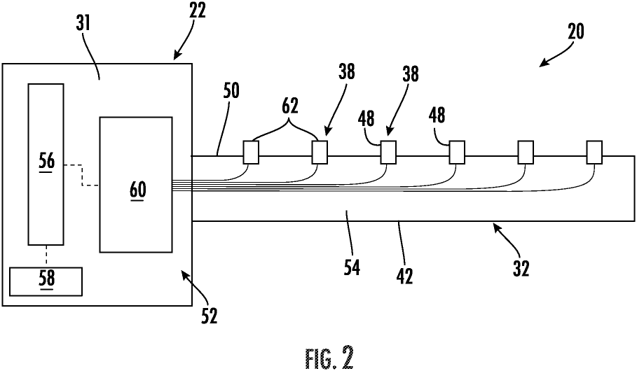

With reference to FIG. 1, an exemplary electronic air cleaner 20 is illustrated. As shown, the air cleaner 20 includes a housing 22 having a first portion or base 24 and a second portion or cover 26. The cover 26 may be removably coupled to the base 24, such as via a plurality of fasteners, a snap fit connection, or in any other suitable manner. Alternatively, the cover 26 may be permanently affixed to the base 24. In an embodiment, the base 24 includes a bottom 28 arranged at a first end and a plurality of sidewalls 30 extending from the bottom 28 in the same direction such that a hollow interior or cavity 31 (see FIG. 2) is defined therebetween. The cover 26 may be configured to mount to the distal end of the plurality of sidewalls 30 to substantially seal the open end of the cavity 31. However, it should be understood that embodiments where the cavity 31 is formed in the cover 26 and embodiments where the cavity 31 is defined by both the cover 26 and the base 24 in combination are also contemplated herein.

Extending from the cover 26 in a direction away from the base 24 is a brush array 32. As shown, the brush array 32 may be arranged substantially orthogonal to the adjacent surface 34 of the cover 26. However, embodiments where the brush array 32 has another orientation relative to the cover 26 are within the scope of the disclosure. In an embodiment, the brush array 32 is a separate component fixedly or removably mounted to the cover 26. In another embodiment, the brush array 32 is integrally formed with the cover 26.

In the illustrated, non-limiting embodiment, the brush array 32 includes a body or structural member 36 capable of supporting one or more brush assemblies 38. The brush array 32 may be formed as a single unitary body, or alternatively, may be formed by connecting multiple components, such as an upper portion and a lower portion for example. As shown, the body 36 may have a first arm 40 and second arm 42 arranged parallel to one another and separated by a clearance 44. The first and second arms 40, 42 may be connected at a distal end thereof, as shown, such that the body 36 is generally U-shaped. Further, the first and second arm 40, 42 may be substantially identical and/or the thickness of the body 36, measured perpendicular to the longitudinal axis of the body 36, may be constant or may vary. It should be understood that embodiments where the brush array 32 has another configuration, such as a circular configuration for example, are also contemplated herein.

In some embodiments, such as where the body 36 is configured to support a plurality of brush assemblies 38 and therefore is generally elongated in the longitudinal direction, the brush array 32 may additionally one or more cross-members 46 that span the clearance 44 to connect the first arm 40 and the second arm 42. Inclusion of a cross-member 46 may increase the structural rigidity of the body 36. The cross-members 46 may be separate components or may be integrally formed with one or both of the first and second arms 40, 42.

A plurality of openings or bores 48 (shown in FIG. 2) are formed in an upper surface 50 of body 36. The total number of openings 48 will vary based on the total number of brush assemblies. Although the openings 48 are formed in each of the arms 40, 42 and each opening 48 is axially aligned with at least one opening on the same arm and at least one opening on the opposite arm, embodiments where the openings 48 are not aligned with one another are also contemplated herein.

In an embodiment, the electronic air cleaner 20 additionally includes an ionizing system 52 (see FIG. 2) All of a portion of the ionizing system 52 may be arranged within the cavity 31 of the housing 22. At least part of the body 36 of the brush array 32, such as the first arm 40 and the second arm 42 for example, has a hollow interior 54. Accordingly, in an embodiment, a portion of the ionizing system 52 is arranged within the body 36 of the brush array 32, such as within hollow interior 54. The ionizing system 52 may include a circuit board 56 and a power supply 58 operably coupled to the circuit board 56 to provide power to one or more components of the air cleaner 20. The ionizing system 52 may additionally include an ion generation device 60 that is operably coupled to the circuit board 56 and is configured to receive power therefrom to produce ions.

The one or more brush assemblies 38 are connected to the ion generation device 60. Each brush assembly 38 includes at least one high voltage wire or electrode 62 that extends through the hollow interior 54 of the body 36 and an opening 48 formed in the body 36 of the brush array 32. In embodiments where a brush assembly includes two electrodes 62, the electrodes are mounted via two separate respective openings 48, such as an opening in the first arm 40 and an axially aligned opening 48 in the second arm 42. However, embodiments where the two electrodes are mounted to the same portion of the body 36, such as the same arm for example, are also contemplated herein.

In an embodiment, the electrode 62 contains a brush 64 including a plurality of bristles that extend outwardly from the brush 64. The brush 64 may be made of any suitable material that conducts electricity. In the illustrated, non-limiting embodiment, the ionizing system 52 includes six brush assemblies 38, each having two electrodes 62. However, embodiments where the ionizing system 52 includes any number of brush assemblies 38, including a single brush assembly or two brush assemblies, are also within the scope of the disclosure.

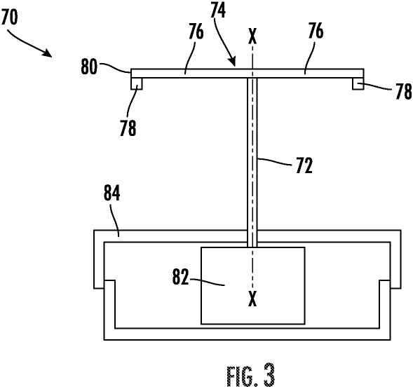

With continued reference to the FIG. 1 and further reference to FIG. 3, at least one self-cleaning assembly 70 for cleaning one or more of the brush assemblies 38 is removably coupled to electronic air cleaner 20, such as at a position adjacent to the brush array 32. As shown, the self-cleaning assembly 70 includes a rotatable support shaft 72 and at least one connecting member 74 extending from the support shaft 72. In the illustrated, non-limiting embodiment, the support shaft 72 is oriented generally vertically and the connecting member 74 extends orthogonally from the support shaft 72. It should be understood that the illustrated configuration is intended as an example only and that embodiments where the support shaft 72 has another orientation and/or embodiments where the connecting member 74 extends at another angle relative to the support shaft 72.

The connecting member 74 includes at least one arm 76. As shown, the connecting member may have two arms 76 that extend from the support shaft 72 in opposite directions in certain instances. However, embodiments where the connecting member 74 has a single arm, or alternatively, more than two arms, such as three arms of four arms for example, are also contemplated herein. The total number of arms 76 may vary based on the application of the self-cleaning assembly 70, such as based on the total number and configuration of the brushes 64 to be cleaned by the self-cleaning assembly 70, for example. In embodiments where the connecting member 74 includes a plurality of arms 76, the arms 76 may but need not be spaced equidistantly and/or integrally formed with one another. Further, it should be understood that embodiments where the self-cleaning assembly 70 includes a plurality of connecting members 74 mounted to the support shaft 72 are also within the scope of the disclosure. The plurality of arms 76 of a connecting member 74 may be the same length, or alternatively, may be different lengths. Similarly, in embodiments having a plurality of connecting members 74, the lengths of the arms 76 of each connecting member 74 may be the same or different.

In an embodiment, at least one cleaning body 78 is arranged adjacent to a free end 80 of each arm 76 of the one or more connecting members 74, and therefore is movable about the axis x. The cleaning bodies 78 may be separate components removably mounted to the arm 76. or alternatively, may be integrally formed with, and therefore considered part of the arm 76. Further, although the plurality of cleaning bodies 78 are shown as being located near the free end 80 of the connecting members 74. embodiments where one or more of the cleaning bodies 78 are arranged at another position about the connecting member 74 are within the scope of the disclosure The cleaning body 78 may be made of any material and may have any configuration suitable for use with the electrodes 62, such as the brushes 64 of the electrodes. In embodiments where a connecting member 74 includes a plurality of arms 76 and/or embodiments including a plurality of connecting members 74, the cleaning bodies 78 may, but need not be the same.

The support shaft 72 is operably coupled to, or alternatively, may be the shaft of a motor 82 and therefore is configured to rotate about an axis X. Because the one or more connecting members 74 are fixedly mounted to the support shaft 72, the connecting members 74 are also rotated about the axis X by the motor 82. As the support shaft 72 and connecting members 74 rotate, the cleaning bodies 78 contact and brush or wipe dirt and debris that has accumulated on a surface of the electrode(s) 62 or brush(es) 64.

The self-cleaning assembly 70 additionally includes a mounting bracket 84 for mounting the assembly 70 to the brush array 32. in the illustrated, non-limiting embodiment, the mounting bracket 84 is configured to surround a portion of the body 36 of the brush array 32. As shown, the mounting bracket 84 includes a plurality of pieces, such as two U or C-shaped pieces for example, that selectively couple to one another. The pieces may connect via a snap fit connection or another quick connection for example, to attach the mounting bracket 84 to the brush array 32. A width of each of the pieces is greater than the width of the brush array 32 such that the body 36 of the brush array 32 is receivable within the interior defined between the coupled pieces. However, it should be understood that a removably connectable mounting bracket 84 having any suitable configuration is within the scope of the disclosure.

When the mounting bracket 84 is affixed to the brush array 32, the support shaft 72 is positioned such that at least one arm 76 of the connecting member 74 overlaps at least one electrode 62 as it rotates about the axis X. Although the end of the arms 76 is shown as being configured to overlap the electrodes 62, embodiments where a central portion of an arm is configured to overlap one or more electrodes 62 are also contemplated herein. Furthermore, the position of the cleaning bodies 78 will vary based on the portion of the arm 76 that overlaps with the one or more electrodes 62. In the illustrated, non-limiting embodiment, the motor 82 and support shaft 72 are arranged centrally between the plurality of electrodes 62 to be cleaned by each self-cleaning assembly 70, such as within the clearance 44 defined between the arms 40, 42 and cross-members 46. In other embodiments the motor 82 and/or support shaft 72 may be arranged at another position relative to the plurality of electrodes 62 to be cleaned by the self-cleaning assembly 70.

A removable self-cleaning assembly 70 as described herein enables extended performance of a low cost air cleaner by fixing the mounting location of the self-cleaning assembly Additionally, the mounting bracket of the self-cleaning assembly simplifies installation of the self-cleaning assembly by reducing the integration wiring required to power the self-cleaning assembly.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A self-cleaning assembly for cleaning at least one electrode of an electronic air cleaner, the self-cleaning assembly comprising:
a mounting bracket, the mounting bracket being removably connectable to the electronic air cleaner;
a connecting member having at least one arm, the connecting member being rotatable about an axis; and
at least one cleaning body arranged at a portion of the at least one arm.

2. The self-cleaning assembly of claim 1, wherein the at least one arm further comprises a plurality of arms and the at least one cleaning body includes a plurality of cleaning bodies, each of the plurality of cleaning bodies being arranged at a portion of one of the plurality of arms.

3. The self-cleaning assembly of claim 2, wherein the plurality of arms includes a first arm and a second arm and a length of the first arm is equal to a length of the second arm.

4. The self-cleaning assembly of claim 2, wherein the plurality of arms includes a first arm and a second arm and a length of the first arm is different from a length of the second arm.

5. The self-cleaning assembly of claim 1, wherein the at least one cleaning body is located near an end of the at least one arm.

6. The self-cleaning assembly of claim 1, wherein the at least one cleaning body is located near a central portion of the at least one arm.

7. The self-cleaning assembly of claim 1, wherein the mounting bracket further comprises a plurality of pieces, the plurality of pieces being removably connected to one another.

8. The self-cleaning assembly of claim 7, further comprising:
a support shaft operably coupled to the connecting member; and
a motor operably coupled to the support shaft, wherein a hollow interior is formed between the plurality of pieces and the motor is mounted within the hollow interior.

9. The self-cleaning assembly of claim 1, further comprising:
a support shaft operably coupled to the connecting member; and
a motor operably coupled to the support shaft, wherein the support shaft extends through the mounting bracket.

10. An electronic air cleaner comprising:
a brush array;
an ionizing system including a brush assembly having at least one electrode, the at least one electrode being mounted to the brush array; and
a self-cleaning assembly removably coupled to the brush array, the self-cleaning assembly including at least one movable cleaning body operable to contact the at least one electrode.

11. The electronic air cleaner of claim 10, wherein the at least one electrode further comprises a plurality of electrodes and the at least one movable cleaning body is operable to contact the plurality of electrodes.

12. The electronic air cleaner of claim 10, wherein the brush array includes a body and the self-cleaning assembly further comprises a mounting bracket, the mounting bracket being removably connected to the body.

13. The electronic air cleaner of claim 12, wherein the body further comprises a first arm and a second arm separated by a clearance, the mounting bracket being coupled to both the first arm and the second arm.

14. The electronic air cleaner of claim 13, wherein at least a portion of the self-cleaning assembly is arranged within the clearance.

15. The electronic air cleaner of claim 12, wherein the mounting bracket further comprises a plurality of pieces, the plurality of pieces being removably connected to one another.

16. The electronic air cleaner of claim 12, wherein the self-cleaning assembly further comprises:
a motor;
a support shaft operably coupled to the motor, the support shaft being rotatable about an axis; and
at least one connecting member rotatably coupled to the support shaft, wherein the at least one movable cleaning body is mounted to the at least one connecting member.

17. The electronic air cleaner of claim 16, wherein the mounting bracket has a hollow interior and the motor is mounted within the hollow interior.

18. The electronic air cleaner of claim 16, wherein the support shaft extends through the mounting bracket.

19. The electronic air cleaner of claim 16, wherein the at least one electrode further comprises a plurality of electrodes and the support shaft is arranged centrally relative to the plurality of electrodes.

20. The electronic air cleaner of claim 16, wherein the at least one connecting member includes a plurality of connecting members.
